(19) United States
(12) Patent Application Publication
(10) Pub. No.: US 2022/0410017 A1
(43) Pub. Date: Dec. 29, 2022

(54) PROVABLY FAIR GAMES USING A BLOCKCHAIN

(71) Applicant: nChain Licensing AG, Zug (CH)

(72) Inventors: Jack Owen DAVIES, London (GB); Chloe TARTAN, London (GB); Craig Steven WRIGHT, London (GB)

(21) Appl. No.: 17/779,997

(22) PCT Filed: Nov. 3, 2020
(86) PCT No.: PCT/IB2020/060296

§ 371 Date: May 25, 2022

(30) Foreign Application Priority Data
Nov. 27, 2019 (GB) 1917287.3

(51) Int. Cl. A63F 13/792; A63F 13/73

(52) U.S. Cl. CPC A63F 13/792; A63F 13/73

(57) ABSTRACT

A computer-implemented method of pseudo-randomly generating winning game elements for use in playing a game. An oracle obtains: a set of seed data items, the set of seed data items comprising one or more user seed data items; and a sequence of first public keys, each first public key representing a respective one of the set of first game elements. The oracle generates an output of a game transaction that comprises an output script. The script comprises the sequence of at least some of the first public keys, and wherein the output script is configured to, when executed, generate at least one pseudorandom number, the pseudorandom number being based on the set of seed data items, and to select a winning key, the winning public key being the public key at a position in the sequence of first public keys corresponding to the pseudorandom number.

### CROSS REFERENCE TO RELATED APPLICATIONS

This application is the U.S. National Stage of International Application No. PCT/IB2020/060296 filed on Nov. 3, 2020, which claims the benefit of United Kingdom Patent Application No. 1917287.3, filed on Nov. 27, 2019, the contents of which are incorporated herein by reference in their entireties.

### TECHNICAL FIELD

The present disclosure relates to methods for randomly generating game elements in order to enable provably fair games to be played out using a blockchain.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to lay additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance, this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, the additional user data will thus remain stored at each of the nodes in the P2P network as an immutable public record.

A game of chance is a game whose outcome is strongly influenced by some randomizing device, and upon which participants may choose to wager money or anything of monetary value. Common devices used to influence the outcome of a game include dice, playing cards, roulette wheels, numbered balls drawn from a container, etc. It is common for these games to be played out online, i.e. at least some of the participants of the game are not physically located in the same place. For example, participants may play a game over the internet. Dedicated sites for hosting games online are often referred to as online casinos.

### SUMMARY

A problem with online casinos (or online games in general) is the lack of transparency (and therefore trust) of the randomizing device. In other words, in a game where the outcome is to at least some extent dependent on a degree of randomness, it is usually not possible for the participants to see how the degree of randomness has been generated. The participants therefore cannot know if the game is being played fairly. This is particularly problematic when the participants are wagering (i.e. betting) on the outcome of the game. As an illustrative example, if participants are playing roulette at an online casino, the participants have to trust that the casino is fairly generating the winning position (i.e. number).

It would therefore be desirable to be provide a technique for evidencing the random generation of the outcome(s) of a game. In this case the random generation will be a pseudorandom process (a deterministic process that givers statistically random results).

According to one aspect disclosed herein, there is provided a computer-implemented method of pseudo-randomly generating winning game elements for use in playing a game, wherein the game comprises a set of first game elements used to determine an outcome of the game, wherein the game is played by a current user, and wherein the method is performed by an oracle and comprises: obtaining a set of seed data items, wherein the set of seed data items comprises one or more user seed data items generated by a respective user; obtaining a sequence of first public keys, each first public key representing a respective one of the set of first game elements; generating a first output of a game transaction, wherein the first output comprises an output script comprising the sequence of at least some of the first public keys, and wherein the output script is configured to, when executed, generate at least one first pseudorandom number, the at least one first pseudorandom number being based on the set of seed data items, and to select at least one first winning key, the at least one first winning public key being the public key at a position in the sequence of first public keys corresponding to the at least one first pseudorandom number.

Herein, a game element is used to refer to any component of a game which is used to decide the outcome of the game. For example, if a game involves the use of playing cards to decide the outcome, the playing cards are the game elements (or at least some of the set of game elements). If a game involves a die or dice, the faces (i.e. numbers) on the die or dice are the game elements (or at least some of them). If the game is roulette, the game elements may be numbers on the roulette wheel.

The oracle (i.e. the party responsible for introducing randomness into the game) obtains a user seed data item from a current user (current game player), which is used to generate a pseudorandom number, which in turn is used to decide an outcome of the game. Since the current user provides their own seed, s/he can be confident that the pseudorandom number has been generated fairly, and that the winning game element selected based on the pseudorandom number has been selected fairly. Now it is not enough purely for the user to contribute to the generation of the pseudorandom number. Instead, the generation of the pseudorandom number must be evidenced so that the user can check that it has been generated in accordance with any agreed upon rules. Therefore the oracle generates a game transaction which includes a script for generating the pseudorandom number, and for selecting the winning game element from a list of all possible game elements (which are represented in script using public keys). The oracle can publish the game transaction to the blockchain and/or the current user so that the user can see how the winning public key, and therefore the winning game element, has been selected.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain;

FIG. 2 schematically illustrates some examples of transactions which may be recorded in a blockchain;

FIG. 3 is a schematic block diagram of another system for implementing a blockchain;

FIG. 4 is a schematic block diagram of a piece of node software for processing transactions in accordance with a node protocol of an output-based model;

FIG. 5 is a schematic block diagram of a system for implementing a provably fair game using the blockchain;

FIG. 6 illustrates an example execution flow of a script <R_{N}> for generating a random number R_{N}; and

FIG. 7 illustrates an example execution flow of a script <Pₖ₌₀> for selecting a winning public key.

### DETAILED DESCRIPTION OF EMBODIMENTS

### Example System Overview

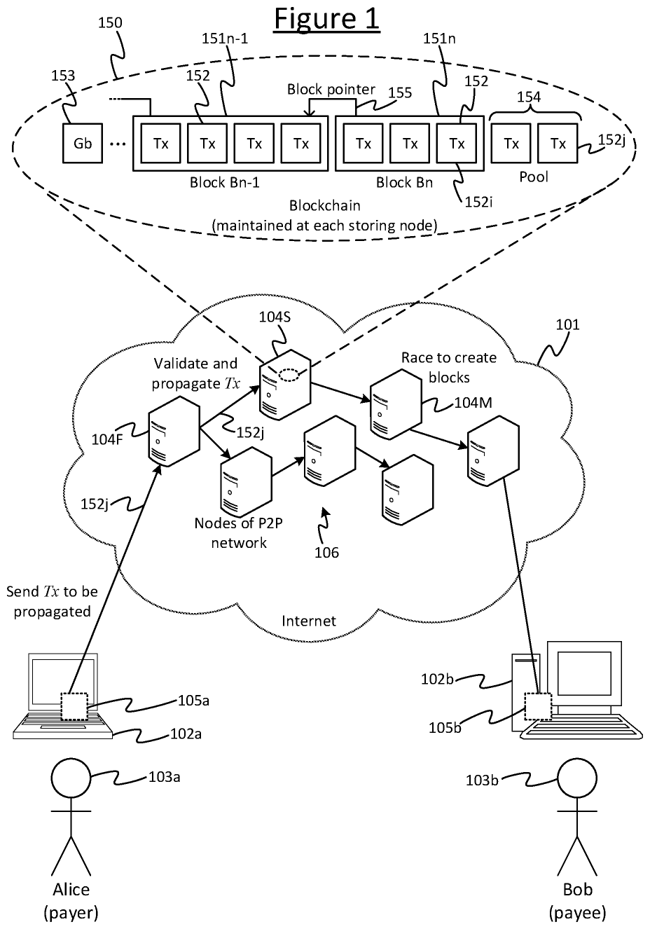

FIG. 1 shows an example system 100 for implementing a blockchain 150 generally. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases a transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transition 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n-1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application or software 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

The instance of the client application 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 (other than a generation transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

UTXO-Based Model

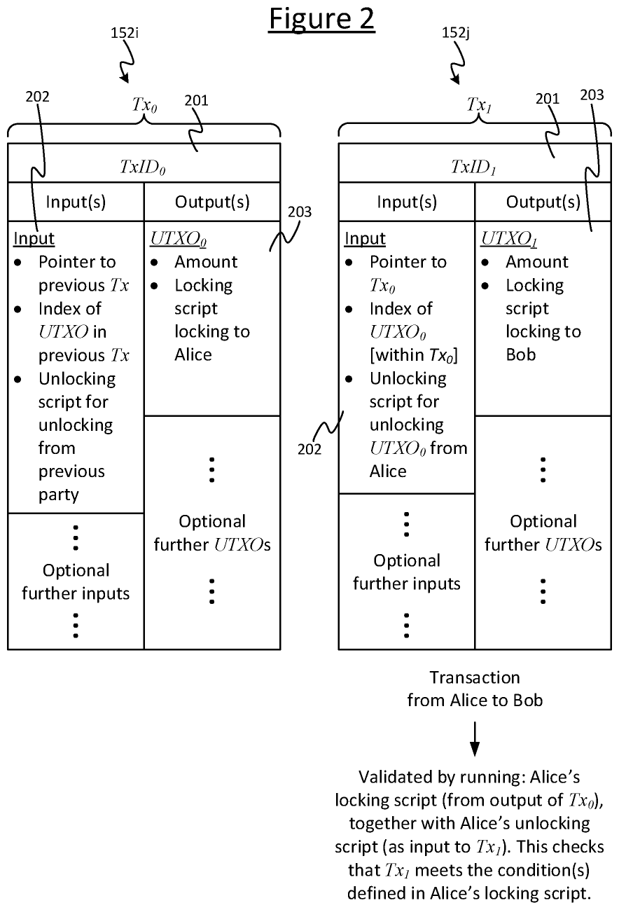

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset (a store of value). It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Note that whilst each output in FIG. 2 is shown as a UTXO, a transaction may additionally or alternatively comprise one or more unspendable transaction outputs.

Say Alice 103a wishes to create a transaction 152j transferring an amount of the digital asset in question to Bob 103b. In FIG. 2 Alice's new transaction 152j is labelled “T_{X1}”. It takes an amount of the digital asset that is locked to Alice in the output 203 of a preceding transaction 152i in the sequence, and transfers at least some of this to Bob. The preceding transaction 152i is labelled “T_{X0}” in FIG. 2. T_{X0} and T_{X1} are just an arbitrary labels. They do not necessarily mean that T_{X0} is the first transaction in the blockchain 151, nor that T_{X1} is the immediate next transaction in the pool 154. T_{X1} could point back to any preceding (i.e. antecedent) transaction that still has an unspent output 203 locked to Alice.

The preceding transaction T_{X0} may already have been validated and included in the blockchain 150 at the time when Alice creates her new transaction T_{X1}, or at least by the time she sends it to the network 106. It may already have been included in one of the blocks 151 at that time, or it may be still waiting in the pool 154 in which case it will soon be included in a new block 151. Alternatively T_{X0} and T_{X1} could be created and sent to the network 102 together, or T_{X0} could even be sent after T_{X1} if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction T_{X0} comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of T_{X0} comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key P_{A} from a public-private key pair of Alice. The input 202 of T_{X1} comprises a pointer pointing back to T_{X1} (e.g. by means of its transaction ID, TxID₀, which in embodiments is the hash of the whole transaction T_{X0}). The input 202 of T_{X1} comprises an index identifying UTXO₀ within T_{X0}, to identify it amongst any other possible outputs of T_{X0}. The input 202 of T_{X1} further comprises an unlocking script <Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction T_{X1} arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the unlocking script (in this example a stack-based language). Equivalently the scripts may be run one after another, with a common stack, rather than concatenating the scripts. Either way, when run together, the scripts use the public key P_{A} of Alice, as included in the locking script in the output of T_{X0}, to authenticate that the locking script in the input of T_{X1} contains the signature of Alice signing the expected portion of data. The expected portion of data itself (the “message”) also needs to be included in T_{X0} order to perform this authentication. In embodiments the signed data comprises the whole of T_{X0} (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature.

If the unlocking script in T_{X1} meets the one or more conditions specified in the locking script of T_{X0} (so in the example shown, if Alice's signature is provided in T_{X1} and authenticated), then the node 104 deems T_{X1} valid. If it is a mining node 104M, this means it will add it to the pool of transactions 154 awaiting proof-of-work. If it is a forwarding node 104F, it will forward the transaction T_{X1} to one or more other nodes 104 in the network 106, so that it will be propagated throughout the network. Once T_{X1} has been validated and included in the blockchain 150, this defines UTXO₀ from T_{X0} as spent. Note that T_{X1} can only be valid if it spends an unspent transaction output 203. If it attempts to spend an output that has already been spent by another transaction 152, then T_{X1} will be invalid even if all the other conditions are met. Hence the node 104 also needs to check whether the referenced UTXO in the preceding transaction T_{X0} is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in T_{X0} can be split between multiple UTXOs in T_{X1}. Hence if Alice does not want to give Bob all of the amount defined in UTXO₀, she can use the remainder to give herself change in a second output of T_{X1}, or pay another party.

In practice Alice will also usually need to include a fee for the winning miner, because nowadays the reward of the generation transaction alone is not typically sufficient to motivate mining. If Alice does not include a fee for the miner, T_{X0} will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to T_{X1}, and T_{X1} has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Note also that if the total amount specified in all the outputs 203 of a given transaction 152 is greater than the total amount pointed to by all its inputs 202, this is another basis for invalidity in most transaction models. Therefore such transactions will not be propagated nor mined into blocks 151.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [ChecksigP_{A}] to mean [ChecksigP_{A}]=OP_DUP OP_HASH160<H(Pa)> OP_EQUALVERIFY OP_CHECKSIG. “OP_. . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

Optional Side Channel

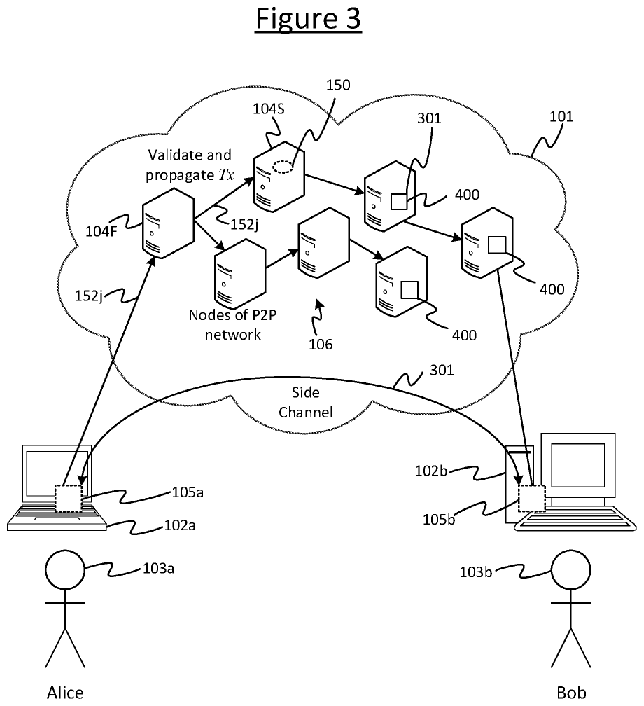

FIG. 3 shows a further system 100 for implementing a blockchain 150. The system 100 is substantially the same as that described in relation to FIG. 1 except that additional communication functionality is involved. The client application on each of Alice and Bob's computer equipment 102a, 120b, respectively, comprises additional communication functionality. That is, it enables Alice 103a to establish a separate side channel 301 with Bob 103b (at the instigation of either party or a third party). The side channel 301 enables exchange of data separately from the P2P network. Such communication is sometimes referred to as “off-chain”. For instance this may be used to exchange a transaction 152 between Alice and Bob without the transaction (yet) being published onto the network P2P 106 or making its way onto the chain 150, until one of the parties chooses to broadcast it to the network 106. Alternatively or additionally, the side channel 301 may be used to exchange any other transaction related data, such as keys, negotiated amounts or terms, data content, etc.

The side channel 301 may be established via the same packet-switched network 101 as the P2P overlay network 106. Alternatively or additionally, the side channel 301 may be established via a different network such as a mobile cellular network, or a local area network such as a local wireless network, or even a direct wired or wireless link between Alice and Bob's devices 1021, 102b. Generally, the side channel 301 as referred to anywhere herein may comprise any one or more links via one or more networking technologies or communication media for exchanging data “off-chain”, i.e. separately from the P2P overlay network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

Node Software

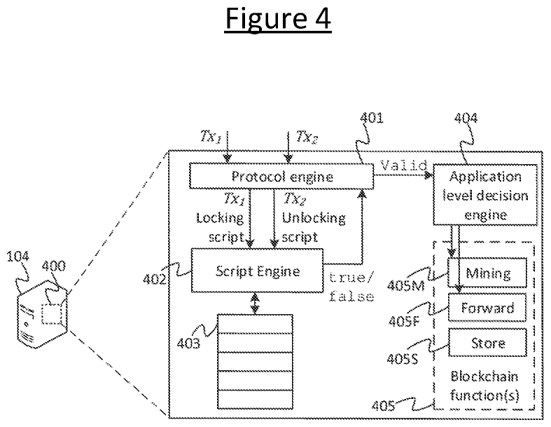

FIG. 4 illustrates an example of the node software 400 that is run on each node 104 of the P2P network 106, in the example of a UTXO- or output-based model. The node software 400 comprises a protocol engine 401, a script engine 402, a stack 403, an application-level decision engine 404, and a set of one or more blockchain-related functional modules 405. At any given node 104, these may include any one, two or all three of: a mining module 405M, a forwarding module 405F and a storing module 405S (depending on the role or roles of the node). The protocol engine 401 is configured to recognize the different fields of a transaction 152 and process them in accordance with the node protocol. When a transaction 152m (Txₘ) is received having an input pointing to an output (e.g. UTXO) of another, preceding transaction 152m-1 (Txₘ₋₁), then the protocol engine 401 identifies the unlocking script in Txₘ and passes it to the script engine 402. The protocol engine 401 also identifies and retrieves Txₘ₋₁ based on the pointer in the input of Txₘ. It may retrieve Txₘ₋₁ from the respective node's own pool 154 of pending transactions if Txₘ₋₁ is not already on the blockchain 150, or from a copy of a block 151 in the blockchain 150 stored at the respective node or another node 104 if Txₘ₋₁ is already on the blockchain 150. Either way, the script engine 401 identifies the locking script in the pointed-to output of Txₘ₋₁ and passes this to the script engine 402.

The script engine 402 thus has the locking script of Txₘ₋₁ and the unlocking script from the corresponding input of Txₘ. For example Tx₁ and Tx₂ are illustrated in FIG. 4, but the same could apply for any pair of transactions, such as Tx₀ and Tx₁, etc. The script engine 402 runs the two scripts together as discussed previously, which will include placing data onto and retrieving data from the stack 403 in accordance with the stack-based scripting language being used (e.g. Script).

By running the scripts together, the script engine 402 determines whether the unlocking script meets the one or more criteria defined in the locking script—i.e. does it “unlock” the output in which the locking script is included? The script engine 402 returns a result of this determination to the protocol engine 401. If the script engine 402 determines that the unlocking script does meet the one or more criteria specified in the corresponding locking script, then it returns the result “true”. Otherwise it returns the result “false”.

In an output-based model, the result “true” from the script engine 402 is one of the conditions for validity of the transaction. Typically there are also one or more further, protocol-level conditions evaluated by the protocol engine 401 that must be met as well; such as that the total amount of digital asset specified in the output(s) of Txₘ does not exceed the total amount pointed to by the input(s), and that the pointed-to output of Txₘ₋₁ has not already been spent by another valid transaction. The protocol engine 401 evaluates the result from the script engine 402 together with the one or more protocol-level conditions, and only if they are all true does it validate the transaction Txₘ. The protocol engine 401 outputs an indication of whether the transaction is valid to the application-level decision engine 404. Only on condition that Txₘ is indeed validated, the decision engine 404 may select to control one or both of the mining module 405M and the forwarding module 405F to perform their respective blockchain-related function in respect of Txₘ. This may comprise the mining module 405M adding Txₘ to the node's respective pool 154 for mining into a block 151, and/or the forwarding module 405F forwarding Txₘ to another node 104 in the P2P network 106. Note however that in embodiments, while the decision engine 404 will not select to forward or mine an invalid transaction, this does not necessarily mean that, conversely, it is obliged to trigger the mining or the forwarding of a valid transaction simply because it is valid. Optionally, in embodiments the decision engine 404 may apply one or more additional conditions before triggering either or both functions. E.g. if the node is a mining node 104M, the decision engine may only select to mine the transaction on condition that the transaction is both valid and leaves enough of a mining fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model (not illustrated in FIG. 4), a result of “true” could be indicated by a combination of an implicit, protocol-level) validation of a signature by the node 104 and an additional affirmative output of a smart contract (the overall result being deemed to signal true if both individual outcomes are true).

Random Number Generation

Hash functions may be used to generate random numbers. The construction of a blockchain is typically based on the use of hash functions, and their inherent properties. Here a hash function H is defined as a one-way deterministic function that takes an arbitrary data structure X and outputs a number with a fixed number of bits or symbols, e.g. a 256-bit number H(X)∈ [symbol] ₂₅₆.

Y=H(X), X [symbol] H (X).

Hash functions, such as SHA-256, behave as one-way random oracles. That is to say, if a hash Y is computed from a pre-image X that is not known to a user, it is computationally difficult for the user to find X.

A property of hash functions is that the hashes of two fixed-length output data structures (e.g. the 256-bit data structures), which differ in the value of a single bit only, can be treated as completely unrelated. In other words, a hash value behaves as a true random number with respect to the user, so long as that user does not know the pre-image in its entirety.

This means that by taking a hash value Y—or some function of it—it can be treated as a single random number R, under the assumption that no single party has control over the entire input pre-image X

R:=Rand:=Y=H (X); for unknown X.

By extension, a random number sequence S_{R} of (k+1) random values can be generated by repeatedly hashing an initial random number R₀ using the same arguments

R₀=H(X₀); R₁=H(R₀); Rₖ=H(Rₖ₋₁),

S_{R}=(R₀, R₁, . . . , Rₖ).

Since hash functions are deterministic, any party may reproduce the entire sequence S_{R} with knowledge only of the specific hash function used and the initial pre-image X₀, which hereby acts as a seed.

If this initial pre-image is made public at the time when the random sequence is generated, any node may independently verify that the sequence corresponds to this pre-image.

It is clear then that hash functions may be used to generate random-number sequences provided that no single party involved in generating the random number(s) can manipulate the entire initial pre-image X₀.

In general, the term ‘hash function’ is used to refer to any type of a one-way function with a fixed size output. Hash functions have existing op_codes in the Script language. However, the techniques disclosed herein are not limited to an implementation in script. Further, alternative one-way functions can be used in place of any instance of a hash function. Two examples include:

i) Elliptic Curve (EC) point multiplication—the function E(x)=x·G that is used to generate an EC public key from a private key, where G is the elliptic curve base point and ‘·’ is the EC point multiplication operator. This is a one-way function as it is easy to compute E(x) given x, G but computationally difficult to determine x given E(x), G.

ii) The Rabin function—the function R(x)=x² mod N, where N=pq for p, q both prime. It is easy to find the square R(x) modulo N, while finding square roots ±x given R(x), N is as difficult as factoring N to find p, q, which is computationally hard.

The following describes three variations for generating a random number using the blockchain. Each method involves multiple parties who join to create the random number. The first method uses a combination of hash pre-images to produce a secure random number, while the second uses a combination of the s-components from several signatures. The third method is a hybrid of the two methods. Each method produces a secure random integer R_{N}ϵ{0,N−1}.

First Method: The Hash Method

Consider N players each of whom make public their own hash value Yᵢ=H(Xᵢ), where we stipulate that each player chooses their own secret pre-image Xᵢ. The properties of hash functions allow us to assume that no player can guess another's pre-image given knowledge of the public hash value.

The players then send their secret pre-image Xᵢ to an oracle (trusted third party). This may be done via a secret value distribution technique, but more generally this method to needing could use any secure channel or mechanism for communicating the pre-image to the oracle. The oracle then produces a random number R_{N} via the following method.

Step 1. The oracle verifies that Yᵢ=H(Xᵢ) for the pre-image provided by each player.

The hash values have already been made public prior to the pre-images being sent to the oracle. This ensures that the oracle is fed the correct pre-images as supplied originally by each player. On the blockchain these public values are immutable, and thus cannot be changed by a player after sending the pre-image. This verification step ensures that the oracle will not proceed in generating a random number until all players have supplied it with their chosen secret pre-image.

Step 2. The oracle computes R_{N} as

$${R}_{N} = H ( {\sum }_{i} {X}_{i} ) mod N$$

R_{N} is a random number with respect to each and every player provided only that no player knows all N of the original pre-image values Xᵢ. All of the pre-images are kept secret by the players and are communicated securely to the oracle. This means that there is no way a malicious party may know all these inputs unless they control all players involved. In this case the adversary would trivially be manipulating a random number to be used by itself only.

In all other scenarios, where there is a minimum of one genuine player, the described properties of hash functions mean that they cannot manipulate R_{N} in an advantageous way. This is true even when the adversary controls all N−1 other players. Put simply, there is no way for any party(s) to influence the random number generated by this method that can adversely affect another party.

Note that an additive ‘+’ summation of the preimages Xᵢ may be used as this can be implemented in Script, but it is also possible to use a different operator, such as concatenation, in series analogous to the summation above.

The random number R_{N} is generated in a way that is both (1) unpredictable to any party involved in the process and (2) reproducible via a deterministic process.

As discussed, an extension is that a random number sequence may also be generated by the oracle by repeated hashing of R_{N}.

Second Method: The Signature Method

Consider a player, Alice, who wishes to create a digital signature for a message hash H(m) using her private key S_{A}. Alice has a public key P_{A} associated with her private key in the usual way according to ECC, where G is the elliptic curve base point of order n

P_{A}=S_{A}·G.

There are two components of the digital signature that need to be created: r and s. Alice generates an ephemeral key as a random number k∈ [symbol] ₘ* and uses this to derive part r of the signature as

(Rₓ, R_{y})=k·G,

r=Rₓ.

The part s of the signature is then derived from this in combination with Alice's private key, her hashed message and the ephemeral key as

s=k⁻¹(H(m)+S_{A}*r) mod n.

By concatenating r and s a data structure known as the ECDSA digital signature of the message hash is created

Sig P_{A}=(r,s).

Given separately the values r and s, the full signature may be constructed in script.

Now consider N players each of whom make public a signature Sig Pᵢ as well as a random value rᵢ′ that forms part of a second signature Sig Pᵢ′ whose sᵢ′-component is kept secret.

Sig Pᵢ=(rᵢ,sᵢ),

Sig Pᵢ′=(rᵢ′sᵢ).

Both signatures are signed using the same private key Sᵢ such that it can be verified that both signatures correspond to the same owner of a public key Pᵢ

Pᵢ=Sᵢ·G.

The players then send their secret sᵢ′ values to an oracle, preferably via a secret-sharing technique. The oracle then produces a random number R_{N} via the following method.

Step 1. The oracle constructs Sig Pᵢ′ and verifies that it corresponds to the same entity as Sig Pᵢ for each player.

This second signature is constructed by concatenating the public rᵢ′ value with the secret sᵢ′ value using the distinguished encoding rules (DER) standard. The oracle applies the standard ECDSA signature verification algorithm to both signatures and confirms that they were commonly signed by the owner of the public key Pᵢ. This ensures that another party cannot influence the random number by providing their own signature for a given rᵢ′ value.

Step 2. The oracle computes R_{N} as

$${R}_{N} = H ( {\sum }_{i} {s}_{i}^{′} ) mod N$$

This inherits the same properties outlined in the hash method due to the analogy of one-way hash functions with the one-way process of generating a public key from a private key in ECC.

Replacing Yᵢ→Pᵢ and Xᵢ→sᵢ′ provides an analody between the first and second methods.

A random number R_{N} is generated, as with the hash method, in a way that is both unpredictable to any party involved and verifiable. It should be made clear that the signature method and the hash method are directly analogous to one another and share core properties of their respective methods for random number generation.

In particular, both methods require each user to be responsible for generating a secret value; Xᵢ and sᵢ′ for the hash and signature methods respectively. A key advantage of using the signature method here is that the act of choosing the secret is already standardised under the ECDSA procedure, while choosing an arbitrary hash pre-image is not.

In the signature method, we also have a way to directly verify the secret value sᵢ′ sent to the oracle has been provided by the original proposer of the corresponding public value rᵢ′ by comparison with the primary signature Sig Pᵢ=(rᵢ, sᵢ) that accompanied it. This verification is only an implicit one in the hash method.

In both regimes the random number R_{N} has fulfilled the requirements of being both unpredictable and deterministic. The random number is also verifiable, meaning that there needs to be a way for all network peers to independently verify that R_{N} has been generated in the correct way. This is achieved by demanding that R_{N} itself be calculated and used in the locking script of a transaction.

In this way all the previously-secret sᵢ′ values are published on the blockchain as part of this script, meaning that anybody can verify the random number by constructing the input pre-image of a hash function Σᵢsᵢ′.

The following script may be used for generating a random integer R_{N}ϵ{0, N−1}

<R_{N}>=<s₁′><s₂′> . . . <s_{N}′>OP_ADD OP_ADD OP_HASH256<N> OP_MOD,

where there are N−1 uses of the operator ‘OP_ADD’ and N secret values.

Note that this script can be used for generalised secret values including hash pre-images, partial signatures and combinations of these.

The full redeem script for a transaction can include the verification that each pre-image corresponds to the correct committed hash, that each secret signature component combines with the public component to form the expected signature and that each supplied value has come from the correct player.

Third Method: The Combined Method

The methods presented above are robust to malicious parties attempting to influence the outcome of the random number produced. However, there are many ways in which the hash method and signature method may be extended and combined in order to improve the security and unpredictability of the random number(s) generated.

The simplest combination of the two methods would be for each player to publish a hash value Yᵢ as well as a signature Sig Pᵢ, random value rᵢ′ and their public key Pᵢ. The oracle may then produce a random value as

$${R}_{N} = H ( {\sum }_{i} {X}_{i} + {s}_{i}^{′} ) mod N$$

where each player has also privately computed a secondary signature Sig Pᵢ′=(rᵢ′,sᵢ′). Note that the addition operator ‘+’ here could be replaced in another implementation by another operator, such as concatenation or an XOR.

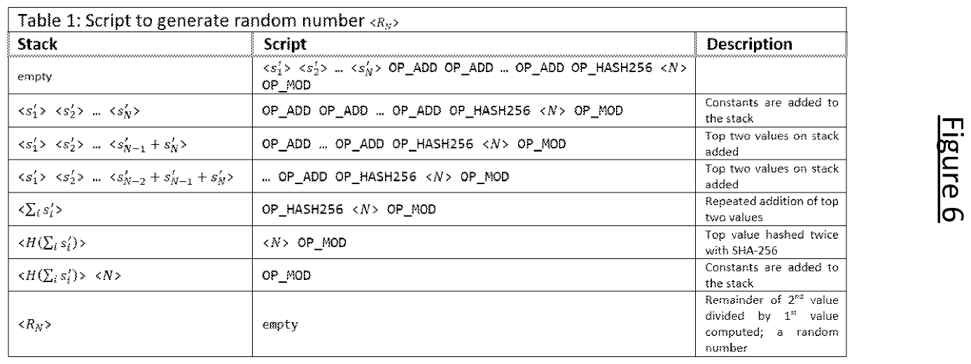

FIG. 6 illustrates an example execution flow of a script <R_{N}> for generating a random number R_{N}.

To extend one of the two methods individually, multiple oracles may be used and players may each provide multiple hash values Yᵢ or secondary rᵢ′ values. For instance, if there are two oracles using the hash method, the random number R_{N} may be calculated as

$${R}_{N} = H ( {\sum }_{i} {X}_{i , 1} + {\sum }_{i} {X}_{i , 2} ) mod N$$

where the first oracle sends the sum of one set of pre-images X_{i,1} to the second, who adds this to the sum of a second set of pre-images X_{i,2} and computes the random number.

By using multiple oracles, the risk of an oracle being somehow corrupted by a malicious user is eliminated. Extending this to a large number of oracles reduces the risk of all oracles colluding, at the expense of greater computational and temporal overheads. Only a single oracle needs to be genuine for the random number to be generated securely and unpredictably.

Provably Fair Games Using Blockchain

The term ‘provably fair’ has become widely used in the gaming literature but is poorly defined. Given the lack of formal definitions in the literature, the following definitions are used herein when discussing implementing provably fair games on-chain.

### Definition 1: Loose Provable Fairness

Start and end states exist on-chain, whilst the logic defining intermediate state transitions can exist off-chain, implemented by a trusted (auditable) oracle, for example. If the initial state can be followed to the end state by only applying the off-chain audited logic, then the game is provably fair.

### Definition 2: Strict Provable Fairness

Virtually all game logic is shown to be provably fair, on-chain, and each state transition is implemented, evidenced and enforced on-chain, e.g. using a blockchain scripting language.

Key-Based Representation of Game Elements

As used herein, the term “game element” is used to refer to a feature of a game which, at least in part, determines the outcome of the game. For instance, in a game of cards, e.g. poker, blackjack, rummy, etc., the game elements are the playing cards. In a game of roulette, the game elements are the numbers which make up the roulette wheel. In a slot machine, the game elements are the symbols of the slot machine reel. The skilled person will appreciate which features of any particular game are considered to be “game elements”.

The present disclosure provides a mechanism for encoding the game elements of a game as keys, e.g. cryptographic private-public key pairs. The following example describes a technique for encoding playing cards, but it will be appreciated that the same technique may be applied to other types of game elements.

In most card games, the outcome of a particular game is determined by the set of cards or ‘hand’ that belongs to each player. The quality of a hand of cards is game-dependent and will be determined by the rules or logic of the game, which is known publicly to the player(s). The winner(s) of a particular game therefore tend to be the player(s) who hold the best hand of cards, according to the rules of the game.

A standard deck of playing cards comprises a set of 52 unique cards, which is formed of four distinct suits—diamonds (D), clubs (C), hearts (H), and spades (S)—each containing the values 2, 3, 4, . . . , 10, J, Q, K, A. Therefore a deck of cards can be treated as a set [symbol] , with 52 unique elements:

[symbol] ={2_{D}, 3_{D}, . . . A_{D}, 2_{C}, 3_{C}, . . . A_{C}, 2_{H}, 3_{H}, . . . , A_{H}, 2_{S}, 3_{S}, . . . , A_{S}}; or

[symbol] ={2D, 3D, . . . AD, 2C, 3C, . . . AC, 2H, 3H, . . . AH, 2S, 3S, AS}.

Depending on the game in question, a player's hand will comprise a combination of one or more of these elements, which is simply a sub-set of [symbol] . Note that, in general, there is no concept of ordering of cards within a given hand, and thus only combinations of cards are relevant, rather than permutations. An example of such a hand h would be the following

hand: h={AD, AC, AH, KD, KS},

which would correspond to a strong hand (i.e. a ‘full house’) in a game such as poker.

The concept of a ‘hand’ can be utilized in a multi-player card game by assigning a set of random key-pairs to each card in the deck [symbol] . By choosing asymmetric key-pairs, such as ECC key-pairs, two new sets of data items can be generated that represent the deck of cards; the set [symbol] of private keys and the set [symbol] of corresponding public keys:

[symbol] ={S_{2D}, S_{3D}, . . . , S_{AD}, S_{2C}, S_{3C}, . . . , S_{AC}, S_{2H}, S_{3H}, . . . , S_{AH}, S_{2S}, S_{3S}, . . . , S_{AS}}; and

[symbol] ={P_{2D}, P_{3D}, . . . , P_{AD}, P_{2C}, P_{3C}, . . . , P_{AC}, P_{2H}, P_{3H}, . . . , P_{AH}, P_{2S}, P_{3S}, . . . , P_{AS}}.

The private-public key-pairs are generated such that each card in the deck is represented by a unique key-pair.

Using these sets of related private and public data that are mapped to a set of playing cards, unique representations of hands can be constructed in a compact and efficient manner. For example, the hand h from above can be represented using either a single private key or a single public key, rather than a 5-element sub-set of [symbol] :

hand: Pₕ=P_{AD}⊕P_{AC}⊕P_{AH}⊕P_{KD}⊕P_{KS}; or

hand: sₕ=s_{AD}⊕s_{AC}⊕s_{AH}⊕s_{KD}⊕s_{KS},

where the binary operator ‘⊕’ represents elliptic curve point addition and the operator ‘+’ represents addition.

Representing hands of cards in this way has a number of advantages. First, a unique representation can be generated from either public data (i.e. public keys), private data (i.e. private keys) or a mixture of the two. This allows winning hands to be generated in such a way that preserves visibility of the card game. For example, the hand Pₕ above can be generated from three ‘public’ cards and two ‘private’ cards, in the same way that a hand in poker is generated as a combination of three face-up cards in the middle of the table and two face down cards belonging to the player. In this case, the three face-up (publicly visible) cards could be P_{AD}, P_{KD}, P_{KS}, representing the cards AD, KD, KS respectively, while the face-down (privately visible to one player) could be s_{Ac}, s_{KS}, representing the AC, KS respectively. The hand can then be publicly represented by a single public key, without necessarily disclosing the two face down cards in the player's hand, as shown below:

Pₕ=P_{AD} ⊕(s_{AC}·G)⊕P_{KD} ⊕P_{KD} ⊕(s_{KS}·G)

Secondly, by using the homomorphic, additive structure of private-public key pairs, hands can be more compactly represented. That is, a hand comprising n cards will either contain y private keys (i.e. y×256 bits of data) or z public keys (i.e. z×33 bytes of data), where y+z=n, whereas a single private key sₕ or a single public key Pₕ each comprise only 256 bits or 33 bytes of data respectively.

Thirdly, locking scripts can be constructed that send funds to keys that represent the entire hand of cards, and such that the script requires the spender to prove knowledge of the winning hand in full. For a game in which a player has face down cards, funds locked using such a script would only be redeemable by the legitimate winner who knows the keys corresponding to their own cards.

The same teaching can be applied to other non-card games. For example, faces of a die may each be represented by a respective private-public key pair. A six-sided die may be mapped to the sets:

[symbol] _{dice}={s₁,s₂,s₃,s₄,s₅,s₆}; and

[symbol] _{dice}={P₁,P₂,P₃,P₄,P₅,P₆}.

In games which depend on the outcome of more than one roll of a die, e.g. craps, the combined outcome may be represented by a single key. As an illustrative example, the game of craps involves a player rolling two dice, with the outcome of the game depending on the total score rolled. The total score may be mapped to the public key P_{score}=P_{die_1}⊕P_{die_2}.

A similar mapping may be constructed for symbols of a slot machine. A slot machine comprises at least one reel, but more typically it comprises three or five reels. Each reel comprises a plurality of symbols, e.g. 22 symbols. Therefore the symbols on each reel may be represented by a set of public-private key pairs, allowing each possible outcome (i.e. the combination of symbols from each reel) to be represented by a single private key or public key.

On-Chain Selection of Game Elements

Many games, particularly games of chance, rely to some extent on the random selection or outcome of game elements. For instance, in a game of playing cards (e.g. poker), the individual cards which are typically drawn from the top of a shuffled deck, whereby shuffling of the deck introduces randomness in the cards which are drawn, either privately to individual players or publicly to all players. Similarly, the outcome of a gamer of roulette depends on the random interactions between a roulette ball and a roulette wheel which result in the ball landing in an unpredictable position (i.e. number) on the wheel. Dice games also rely on the random interaction between the die and the surface on which it is rolled.

The present disclosure recognises that game elements may be randomized on-chain in order to enable provably-fair games. Each game element is represented by a respective public key. A locking script is constructed which comprises the set of public keys required to represent the particular game elements of the game being played, and a random seed, which may have been produced in accordance to one of the previously described methods under “Random Number Generation”, is used to randomly select one of the public keys as a winning public key.

The following randomisation script, denoted by <Pₖ₌₀>, may be used to randomly select a public key from the set of N public keys Pᵢ, where each public key Pᵢ represents a respective game element. The randomisation script is seeded by a random number, e.g. the previously presented script <R_{N}>, which calculates a random number in-situ.

<Pₖ₌₀>=<P₁><P₂> . . . <P_{N}><R_{N}> OP_ROLL OP_TOALTSTACK OP_DROP OP_DROP OP_FROMALTSTACK,

where there are N−1 uses of the operator ‘OP_DROP’ and N public keys.

The opcode OP_ROLL causes an item at a position on the stack equal to a number preceding the opcode to be moved to the top of the stack. E.g. If the opcode OP_ROLL follows the number 3, the third item back in the stack is moved to the top of the stack.

Therefore the set of public keys are manipulated according to the value produced by the sub-script <R_{N}>. This script enables a random public key, and therefore a random game element, to be selected for use in a game. For instance, the randomly selected game element may be the winning outcome for a roulette wheel.

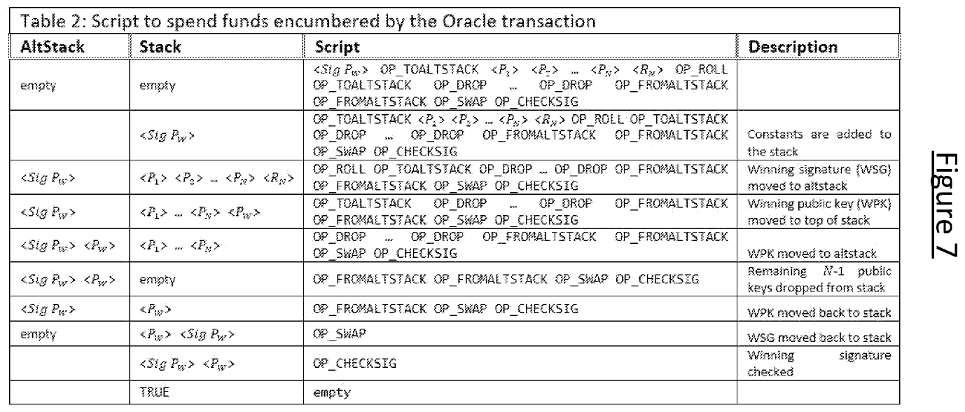

FIG. 7 illustrates an example execution flow of a script <Pₖ₌₀> for selecting a winning public key. In this case, the output script of a game transaction (described below) is executed alongside an input script of a redemption transaction (described below), wherein the input script comprises a signature corresponding to the winning public key.

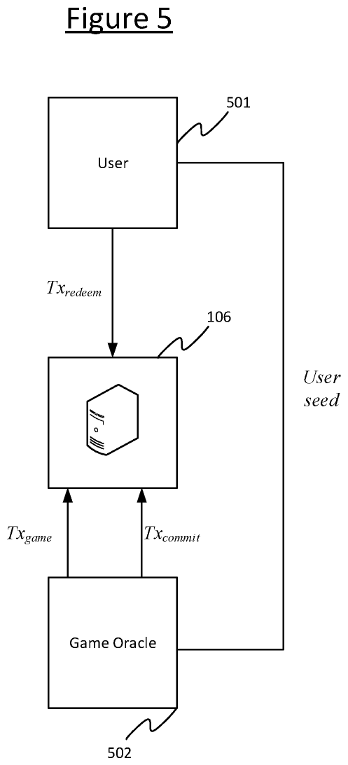

Embodiments of the present disclosure will now be described with reference to FIG. 5. FIG. 5 illustrates a system for playing a game. In general, the game may be played by any number N of users 501 (i.e. players), each user 501 operating respective computer equipment, but for illustrative purposes only a single user is shown in FIG. 5. The game is implemented by a game oracle 502, i.e. e.g. a third party who is not a player of the game. The game oracle may be a smart contract or an autonomous agent. For example, the game oracle may be a computer protocol configured to implement the actions attributed to the game oracle. The game oracle 502 may operate respective computer equipment. FIG. 5 illustrates the oracle 502 obtaining a user seed from a user 501, and sending a commitment transaction and a game transaction to the blockchain network 106 for inclusion in the blockhain 150. FIG. 5 also illustrates the user 501 sending a winning redemption transaction to the blockchain network 106. The previously mentioned transactions will be described below.

The computer equipment of each user 501 and the game oracle 502 (if applicable) comprises respective processing apparatus comprising one or more processors, e.g. one or more CPUs, GPUs, other accelerator processors, application specific processors, and/or FPGAs. The computer equipment of each user 501 and the game oracle 502 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment of each user 501 and the game oracle 502 stores software comprising a respective instance of at least one client application arranged to run on the processing apparatus. It will be understood that any action attributed herein to a given user 501 or the game oracle 502 may be performed using the software run on the processing apparatus of the respective computer equipment. The computer equipment of each user 501 comprises at least one user terminal, e.g. a desktop or laptop computer, a tablet, a smartphone, or a wearable device such as a smartwatch. The computer equipment of a given user 501 or the game oracle 502 may also comprise one or more other networked resources, such as cloud computing resources accessed via the user terminal. The client application or software may be initially provided to the computer equipment of any given user 501 or the game oracle 502 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

Note that whilst described separately here, the users 501 may be the same users 103 as described in FIGS. 1 to 3.

In some examples, the user (i.e. the user's computer equipment) may be able to generate and/or transmit transactions to the blockchain 150. Moreover, the user's computer equipment may be able to read transactions from the blockchain 150. In general, the user 501 may perform any of the actions attributed to Alice 103a and/or Bob 103b as described with reference to FIGS. 1 to 3.

Similarly, the computer equipment of the game oracle 502 is configured to read transactions from and transmit transactions to the blockchain 150.

The user 501 generates a respective data item, referred to as user seed. The user seed may be generated in accordance with any of the first, second or third methods for generating a random number as described above. For example, the user seed may be a respective hash or a respective component of a digital signature. In some examples, the game oracle 502 also generates a seed data item, referred to below as an oracle seed.

The game oracle 502 obtains the user seed (or a hash thereof). The game oracle 502 may obtain the user seed (or the hash thereof) directly from the user 501, e.g. via a (secure) communication channel. Alternatively, the user may publish their user seed (or the hash thereof), e.g. on a website, or to the blockchain 150. That is, the user seed (or the hash thereof) may be included in a blockchain transaction which is transmitted to the blockchain 150 by the user 501 or the game oracle 502. For instance, the user 501 may add an input (and optionally, an output) to a transaction (referred to below as a commit transaction), with their user seed (or hash thereof) included in the input and/or output which that user added to the commit transaction.

In examples where the oracle also provides an oracle seed, the oracle 502 may generate the commitment transaction which includes the oracle seed (or a hash thereof), and then transmit the commitment transaction to the user 501. The user may, in turn, add their user seed (or hash thereof) to the commitment transaction and sign their input with a respective digital signature. Once the user has added their input, the oracle 502 may sign the commitment transaction as a whole and transmit the commitment transaction to the blockchain network 106. In that sense, the oracle 502 may generate a partial commitment transaction which is then sent to the user 501.

The game oracle 502 also obtains a sequence of public keys. Each public key represents a respective game element. The representation of game elements as public keys has been described above. The game oracle 502 may generate the sequence of public keys. Alternatively, the user 501 may generate one or more of the public keys, with the game oracle 502 generating the remaining public keys, if any. For example, the user 501 may provide a public key corresponding to a game element which they predict will be the winning game element, e.g. a game element which the user 501 is wagering on being the winning game element.

In some examples, the oracle 502 may map each public key to a respective game element and publish the mapping. In other examples, the oracle 502 may apply a hash function to the mapping to generate a mapping hash, and then publish the mapping hash. Publishing the mapping or the mapping hash may comprise sending the mapping or mapping hash to the user 501. As another example, the oracle may include the mapping or the mapping hash in a transaction, e.g. the commitment transaction. Preferably the mapping and oracle seed (or the hashes thereof) are known to the user 502 before the user provide their user seed.

When the game oracle 502 has obtained the seed data items (or hashes thereof) and the sequence of public keys, the game oracle 502 generates a game transaction. The game transaction has at least one output which comprises an output script. The output script comprises the sequence of public keys and a portion of script for generating the pseudorandom number based on the set of (hashes of) seed data items. In some examples, the pseudorandom number is generated in advance of the game transaction and is placed in the output script (note that in this case the portion of script for generating the pseudorandom number is simply the pseudorandom number). However, preferably the portion of script comprises the set of seed data items (or the set of hashes) and generates the pseudorandom number in script. The game transaction may spend an output of the commitment transaction.

The generation of a pseudorandom number in script has been generally described above. The output script may combine (e.g. sum) the set of seed data items (or hashes) and take a hash of the combination. The hash of the combination (referred to below as a hash result) is then mapped to a number for use as a pseudorandom number, the mapping being based on the total number of game elements represented by the public keys, or in other words, the total number of public keys in the sequence of public keys. One way to implement the mapping is by performing a modulo operation on the hash result, wherein performing the modulo operation uses the total number of public keys to take the modulus of the hash result.

Similarly, the selection of a public key from a sequence of public keys has been described above. The output script uses the pseudorandom number to select one of the public keys in the sequence of public keys, and therefore the game element represented by the selected public key is chosen pseudorandomly.

The output of the game transaction may be locked to the selected public key (the winning public key). That is, knowledge of the private key corresponding to the winning public key is required in order to unlock the output of the game transaction. In examples where a user has generated the winning public key (that is, a user 501 provided a public key to represent a particular game element and that public key was then selected as the winning public key), the user 501 already has access to the private key and therefore can unlock the output of the gaming transaction. In examples where the oracle generated the winning public key (that is, the oracle 502 generated the public key which was then selected as the winning public key), the oracle 502 may transmit the private key to one or more users 501 playing the game.

In some examples, the output of the game transaction may lock to one of several sets of public keys dependent on the winning public key. That is, if a first public key is selected as the winning public key, the output may be locked to a first set of public keys (which may be one public key or several public keys), and if a different, second public is selected as the winning public key, the output may be locked to a second set of public keys (which may be one public key or several public keys). The first set of public keys may be a set of user public keys, i.e. public keys to which the user has access to the corresponding private key. The second set of public keys may be a set of oracle public keys, i.e. public keys to which the oracle 502 has access to the corresponding private key.

In some examples the outcome of the game may be decided based on more than one game element. For example, in a slots machine, the outcome of the game is typically dependent on the respective symbols on multiple reels. For any such game, the oracle may obtain a sequence of public keys for each set of game elements. Two or more sequences of public keys may represent the same game elements (e.g. two reels on a slot machine may be made up of the same symbols). Alternatively, each sequence of public keys may represent different game elements (e.g. one sequence represents a set of numbers and one sequence represents a set of colours). Regardless of the number of sets of game elements, each corresponding sequence of public keys may comprises multiple public keys that represent the same game element, or in other words, a given game element may be represented by more than one public key (which may or may not be the same public key).

The oracle may generate the game transaction such that it is configured to selected multiple winning public keys, one from each sequence of public keys. That is, the output script is configured to generate multiple pseudorandom numbers, each being generated based on the same set of seed data items. Each pseudorandom number is then used to select a public key from each sequence of public keys.

In some examples, the oracle generates the multiple pseudorandom numbers in advance of generating the game transaction, and inserts the multiple pseudorandom numbers in the output of the game transaction. However, preferably the pseudorandom numbers are generated in script. The same technique used to generate one pseudorandom number in script can be used one or more additional times to generate one or more additional pseudorandom numbers. That is, to generate a first random number, the output script may combine (e.g. sum) the set of seed data items (or hashes) and applying a first hash function to the combination. The hash of the combination (referred to below as a first hash result) is then mapped to a number for use as a first pseudorandom number, the mapping being based on the total number of game elements represented by a first sequence of public keys, or in other words, the total number of public keys in the first sequence of public keys. To generate a second pseudorandom number, the output script may combine (e.g. sum) the set of seed data items (or hashes) and applying a second hash function to the combination. The hash of the combination (referred to below as a second hash result) is then mapped to a number for use as a second pseudorandom number, the mapping being based on the total number of game elements represented by a second sequence of public keys, or in other words, the total number of public keys in the second sequence of public keys. The first and second hash functions may be the same hash function or different hash functions. Here, a different hash function may apply the same hash function multiple times.

The same technique for selecting the first winning public key is used to select one or more additional winning public keys. That is, the game transaction comprises each sequence of public keys and a corresponding portion of script used to select a public key from each sequence based on a corresponding pseudorandom number. That is, a winning public key is selected from a first sequence of public keys based on a first pseudorandom number, a winning public key is selected from a second sequence of public keys based on a second pseudorandom number, and so on.

The output script of the game transaction may lock the output to one or more public keys based on the selected winning public keys. That is, the output of the game transaction may lock to a set of public keys dependent on the winning public key. That is, if one or more predicted public keys are selected as the winning public keys, the output may be locked to one or more user public keys (public keys to which the user has, or is sent, the corresponding private keys). The output script may check that an input of a redemption transaction comprises signatures generated using private keys that correspond to the one or more predetermined public keys. The output script may be a multi-signature output, i.e. an input of a redemption transaction must comprise a predetermined number of signatures generated by respective private keys corresponding to the predicted public keys. The predicted public keys may be provided to the oracle 502 by the user 501, or the user 501 may provide the oracle with predicted game elements for the oracle to generate the predetermined public keys.

On the other hand, if the one or more predicted public keys are not selected as the winning public keys, the output may not be unlocked by the private corresponding to the one or more user public keys. For example, the output may be locked to a different set of public keys (e.g. the oracle's public key).

### Example Use Cases

Use Case 1: Provably Fair Slot Machines

The following describes a step-by-step process of implementing provably fair slot machines on the blockchain. The locking script models a single reel slot machine, with only two public keys (belonging to the player and the house) appearing on a virtual reel. Note that this is a simplified model to illustrate the game logic of in-script slots. Real-life and online slots have many symbols and more complex winning odds than the 50:50 illustrated in the first example below, and so will be developed further in later examples.

Process:
1. The oracle commits a hash digest of the oracle seed H(X₀) in a partially completed commitment transaction Tx_{commit}.
2. The user inputs their bet funds x and a hash digest of the user seed H(X₁) to complete the transaction Tx_{commit}. This ensures an ordering: the user acknowledges that they have seen the oracle's hash commit and attests to this fact by signing over it. Alternatively, the user may provide their seed first. Each seed is provided in an unspendable output (e.g. an OP_RETURN output).
3. Tx_{commit} is mined on the blockchain once it is signed and attested by both the house Sig P₀ and player Sig P₁.

The commitment transaction for a user against the oracle is shown below. In this example, the first input from the oracle uses a SIGHASH|ANYONECANPAY flag, while the second input from the user uses a SIGHASHALL flag to finalize and broadcast the transaction.

Commitment Transaction, TxID_{Commit}

| Inputs | | Outputs | |
|---|---|---|---|
| Value | Unlocking Script | Value | Locking Script |
| 0 | < Sig(P₀)> <P₀> | 0 | OP_RETURN <Oracle Seed: H(X₀)> |
| x | < Sig(P₁)> <P₁> | x | OP_DUP OP_HASH160 <H(P₀)> |
| | | | OP_EQUALVERIFY OP_CHECKSIG |
| | | 0 | OP_RETURN <User Seed: H(X₁)> |

4. The user sends the user seed (preimage X₁) via a secure off-chain communication channel to the oracle's pseudo-random number generator (PRNG).
5. The oracle computes a random number R_{N} in script using both oracle and user seeds H(X₀+X₁), in accordance with the hash method described above. This computation in its generalized form is given as:

$${R}_{N} = H ( {\sum }_{i} {X}_{i} ) mod r ,$$

where i=0, 1, . . . , N cycles through the house (i=0) and each player (i=1, N), and r corresponds to the number of positions (i.e., symbols) on each reel of a slot. Alternative methods for generating the pseudorandom number may be used (e.g. the signature method or combined method).
6. A slot machine spin transaction Txₛₚᵢₙ (the game transaction) is set up by the oracle which spends the UTXO from Tx_{commit} The spin transaction comprises a sequence of public keys representing the game elements (only two in this simplified example).
7. The oracle's funds are added as a secondary input to Txₛₚᵢₙ.
8. The locking script of Txₛₚᵢₙ contains the game logic, which picks the winning symbol(s) from a list of r symbols that are represented by r public keys.

A simple example of Txₛₚᵢₙ is shown in the figure below. If the user's public key is chosen by the random number, the total funds are encumbered to that key. A winnings-redemption transaction following a user's successful spin is also shown below.

Spin Transaction, TxID_{Spin}

| Inputs | | Outputs | |
|---|---|---|---|
| Value | Unlocking Script | Value | Locking Script |
| x | < Sig(P_{O})> <P_{O}> | x + y | <P₀><P₁><R_{N}> OP_ROLL |
| y | < Sig(P_{O})> <P_{O}> | | OP_TOALTSTACK OP_DROP |
| | | | OP_FROMALTSTACK OP_ |
| | | | CHECKSIG |

Winnings-Redemption Transaction, TxID_{Win}

| Inputs | | Outputs | |
|---|---|---|---|
| Value | Unlocking Script | Value | Locking Script |
| x + y | < Sig(P₁)> | x + y | OP_DUP OP_HASH160 <H(P_{Win})> |
| | | | OP_EQUALVERIFY OP_CHECKSIG |

3-Reel Slots:

Traditionally slot machines comprise three or more reels. The simple example in the previous section can be extended to model k>1 reels, where a total of k+1 random numbers are required. This is because typically online slot machines use one unique random number per reel in addition to the random number R_{N} representing a spin, i.e., a player's turn on the slot machine. The oracle can generate the unique random number for the j′th reel R_{N}_{ⱼ} by hashing the random number j times. The general computation for k-reel slots, incorporating the spin can therefore be written as:

R_{N}_{ⱼ}=H^{j}(R_{N})mod r.

The figure below shows the spin transaction for a 3-reel slot machine Tx_{Spin}, where a user's winning outcome results from three matching winning public keys being picked from a virtual spin of each reel. In this example, a set of arbitrary public keys Pₐ, P_{b}, P_{c} P_{Z} are used to represent the symbols in each reel, which is executed using the following script:

[Reel j] = <Pₐ><P_{b}><P_{c}> ... <P_{z}><R_{N}_{₁}> OP_ROLL OP_TOALTSTACK
OP_DROP ...
OP_DROP

The winnings-redemption transaction is also shown below.

Spin Transaction, TxID_{Spin}

| Inputs | | Outputs | |
|---|---|---|---|
| Value | Unlocking Script | Value | Locking Script |
| x | < Sig(P_{O})> <P_{O}> | x + y | [Reel 1] |
| y | < Sig(P_{O})> <P_{O}> | | [Reel 2] |
| | | | [Reel 3] |
| | | | OP_FROMALTSTACK OP_DUP |
| | | | OP_FROMALTSTACK |
| | | | OP_EQUAL OP_IF |
| | | | OP_FROMALTSTACK |
| | | | OP_EQUAL OP_IF |
| | | | OP_DUP OP_HASH160 |
| | | | <H(P_{W})> |
| | | | OP_EQUALVERIFY |
| | | | OP_CHECKSIG |
| | | | OP_ENDIF |
| | | | OP_ELSE |
| | | | OP_DUP OP_HASH160 |
| | | | <H(P₀)> OP_EQUALVERIFY |
| | | | OP_CHECKSIG |
| | | | OP_ENDIF |

Winnings-Redemption Transaction, TxID_{Win}

| Inputs | | Outputs | |
|---|---|---|---|
| Value | Unlocking Script | Value | Locking Script |
| x + y | < Sig(P₁)> <P₁> | x + y | OP_DUP OP_HASH160 <H(P_{Win})> |
| | | | OP_EQUALVERIFY OP_CHECKSIG |

Winning Odds:

Typical weighted slots have 22 actual positions in each reel. Each position (excluding the jackpot) often maps to more than one position on a virtual reel that contains 32, 64, 128, 256 or 512 stops. Assume that the reels are all set in the same way, then for a 64-stop virtual reel the odds of winning the jackpot are actually 1 in 64³ or 262,144. Since the present implementation uses public keys to represent these symbols, a player would not know how many keys map to the same symbol unless the house distributes the mapping before a spin. Since the locking script in Tx_{Spin} releases the funds to the player for any matching combination of keys, the oracle can replicate the odds of the virtual reel in script without having to reveal their chosen mapping or winning odds. However should the player request this information, the house can attest to a hash digest of the mapping <H(Mapping)> in the null data output of the commitment transaction Tx_{commit}, alongside the server and client seeds.

The user can contribute to the key generation process and therefore be in possession of one or more of the private keys associated with the list of r keys. In this case, the user can simply provide the signature derived from the winning private-public keypair(s) in the redemption transaction (e.g., as illustrated in the simplified 1-reel slot example). For the 3-reel slot use case, this would change the conditional statements in the second part of the Tx_{Spin} locking script to:

```
OP_EQUAL OP_IF
  OP_FROMALTSTACK OP_CHECKSIG
OP_ELSE
  OP_DUP OP_HASH160 <H(P₀)> OP_EQUALVERIFY OP_
  CHECKSIG
OP_ENDIF
```

Progressive Jackpots:

Slot machines are conventionally user against the oracle. However, N-players can be playing on different slot machines that are all linked to a single jackpot across a network of slots or casinos. In this case, the order of play is important to determine which single user can claim the entire jackpot. To record this using the described provably fair methods, each user seed may be concatenated with all previous user's hash digests H(X₁∥X₂∥ . . . ∥X_{N}) such that each player's input is always attested sequentially to the blockchain within every Tx_{commit} Note that a new oracle seed X₀ should always be generated and added to the user's input so that the house contributes to the random number generation in each spin. Once a user hits the jackpot, the hash digest can be refreshed to start from scratch.

X-of-Y Bonus Slots:

A commitment of a bet on X-of-Y public keys being chosen from a list of public keys can be made using an m-of-n Multisig. In this example, the user generates public keys that are assigned symbol(s) of their choice. If a winning combination of symbols are chosen, the user can unlock the funds using an m-of-n Multisig. An example spin transaction is shown below where a user bets on 2-of-3 Pₐ symbols being picked on a spin of the 3-reel slot machine.

Spin Transaction, TxID_{Spin}

| Inputs | | Outputs | |
|---|---|---|---|
| Value | Unlocking Script | Value | Locking Script |
| x | < Sig(P_{O})> <P_{O}> | x + y | [Reel 1] |
| y | | | [Reel 2] |
| | | | [Reel 3] |
| | | | OP_FROMALTSTACK |
| | | | OP_FROMALTSTACK |
| | | | OP_FROMALTSTACK |
| | | | 2 <Pₐ> <Pₐ> <Pₐ> 3 |
| | | | OP_CHECKMULTISIG |

Winnings-Redemption Transaction, TxID_{Win}

| Inputs | | Outputs | |
|---|---|---|---|
| Value | Unlocking Script | Value | Locking Script |
| x + y | < Sig(Pₐ)> <Pₐ> | x + y | OP_DUP OP_HASH160 <H(P_{Win})> |
| | < Sig(Pₐ)> <Pₐ> | | OP_EQUALVERIFY OP_CHECKSIG |

The multisig requirement can also be constructed from a set of pay to public key hash (P2PKH) scripts contained within a set of conditional IF or ELSE statements. The locking script below would be executed after the last reel spin as follows:

```
OP_FROMALTSTACK <Pₐ> OP_EQUAL OP_IF
  OP_FROMALTSTACK OP_DUP <Pₐ> OP_EQUAL OP_IF
    OP_CHECKSIG
  OP_ELSE
    OP_DROP OP_FROMALTSTACK OP_DUP <Pₐ> OP_EQUAL OP_IF
      OP_CHECKSIG
    OP_ELSE
      OP_DUP OP_HASH160 <H(P₀)> OP_EQUALVERIFY
    OP_CHECKSIG
    OP_ENDIF
  OP_ENDIF
OP_ELSE
  OP_DROP OP_FROMALTSTACK <Pₐ> OP_EQUAL OP_IF
    OP_FROMALTSTACK OP_DUP <Pₐ> OP_EQUAL OP_IF
      OP_CHECKSIG
    OP_ENDIF
  OP_ELSE
    OP_DUP OP_HASH160 <H(P₀)> OP_EQUALVERIFY OP_CHECKSIG
  OP_ENDIF
OP_ENDIF
```

A step-by-step description of the game logic in the above locking script is given:
1. Check if the first stack item is equal to Pₐ
   a. If yes, check if the second stack item is equal to Pₐ
      i. If yes, lock the funds to Pₐ
      ii. If no, remove the top stack item and check if the third stack item is equal to Pₐ
         1. If yes, lock the funds to Pₐ
         2. If no, lock the funds to the house P₀
   b. If no, remove the top stack item and check if the second stack item is equal to Pₐ
      i. If yes, check if the third stack item is equal to Pₐ
         1. If yes, lock the funds to Pₐ
         2. If no, lock the funds to the house P₀

Use Case 2: Provably Fair Roulette

In this example, the 37 positions (numbers 0-36) on a roulette wheel are mapped to 37 public keys. The hash digest of this mapping can be published on-chain in the commitment transaction Tx_{commit} The same game logic applies here to the slot machine examples given above, whereby a user plays against the house and a spin of the virtual roulette wheel determines the winning position that is selected using a provably fair random number.

The key difference in the game logic is that a user playing around a roulette wheel will bet on a specific outcome e.g., a number, various groupings of numbers, whether the number is odd or even, high or low or the colour (black or red) of the winning position. The odds of winning depend on these groupings, as well as the player's bet size. The funds y contributed from the oracle in the spin transaction can therefore be used to reflect these odds. An example spin transaction is shown below with a player betting on the number 7.

Spin Transaction, TxID_{Spin}

| Inputs | | Outputs | |
|---|---|---|---|
| Value | Unlocking Script | Value | Locking Script |
| x | < Sig(P_{O})> <P_{O}> | x + y | <P₀> <P₁> <P₂> . . . <P₃₆> <R_{N}> |
| y | < Sig(P_{O})> <P_{O}> | | OP_ROLL OP_TOALTSTACK |
| | | | OP_DROP . . . OP_DROP |
| | | | OP_FROMALTSTACK |
| | | | <P₇>OP_EQUAL OP_IF |
| | | | OP_DUP OP_HASH160 |
| | | | <H(P₁)> OP_EQUALVERIFY |
| | | | OP_CHECKSIG |
| | | | OP_ELSE |
| | | | OP_DUP OP_HASH160 |
| | | | <H(P₀)> OP_EQUALVERIFY |
| | | | OP_CHECKSIG |
| | | | OP_ENDIF |

If P₇ is indeed the winning position, the funds can simply be unlocked with the player's signature <Sig (P₁)><P₁>. However, if the player owns the private key for P₇ (and the oracle possesses the private key for all remaining keys), the locking script can simply be written as:

<P₀> <P₁> <P₂> ... <P₃₆> <R_{N}> OP_ROLL OP_TOALTSTACK OP_DROP ... OP_DROP
OP_FROMALTSTACK OP_CHECKSIG

A user betting on a group of numbers e.g., odd numbers, can redeem funds encumbered to a multi-signature address if they possess one of the eighteen private keys associated with the odd numbered public keys:

Spin Transaction, TxID_{Spin}

| Inputs | | Outputs | |
|---|---|---|---|
| Value | Unlocking Script | Value | Locking Script |
| x | < Sig(P_{O})> <P_{O}> | x + y | <P₀> <P₁> <P₂> . . . <P₃₆> <R_{N}> |
| y | < Sig(P_{O})> <P_{O}> | | OP_ROLL OP_TOALTSTACK |
| | | | OP_DROP . . . OP_DROP |
| | | | OP_FROMALTSTACK |
| | | | 1 <P₁> <P₃> <P₅> . . . <P₃₅> 18 |
| | | | OP_CHECKMULTISIG |

For a winning position of P₁₁, the winnings-redemption transaction for the above spin would take the form:

Winnings-Redemption Transaction, TxID_{Win}

| Inputs | | Outputs | |
|---|---|---|---|
| Value | Unlocking Script | Value | Locking Script |
| x + y | < Sig (P₁₁)> <P₁₁> | x + y | OP_DUP OP_HASH160 <H(P_{Win})> |
| | | | OP_EQUALVERIFY OP_CHECKSIG |

### CONCLUSION

It will be appreciated that the above embodiments have been described by way of example only. More generally there may be provided a method, apparatus or program in accordance with any one or more of the following Statements.

Statement 1. A computer-implemented method of pseudo-randomly generating winning game elements for use in playing a game, wherein the game comprises a set of first game elements used to determine an outcome of the game, wherein the game is played by a current user, and wherein the method is performed by an oracle and comprises:
obtaining a set of seed data items, wherein the set of seed data items comprises one or more user seed data items generated by a respective user;
obtaining a sequence of first public keys, each first public key representing a respective one of the set of first game elements;
generating a first output of a game transaction, wherein the first output comprises an output script comprising the sequence of at least some of the first public keys, and wherein the output script is configured to, when executed, generate at least one first pseudorandom number, the at least one first pseudorandom number being based on the set of seed data items, and to select at least one first winning key, the at least one first winning public key being the public key at a position in the sequence of first public keys corresponding to the at least one first pseudorandom number.

Statement 2. The method of statement 1, wherein the set of seed data items comprises an oracle seed data item generated by the oracle.

Statement 3. The method of statement 1 or statement 2, comprising:
generating a commitment transaction, wherein the commitment transaction is a blockchain transaction comprising the oracle seed data item; and
transmitting the commitment transaction to a current one of the respective users.

Statement 4. The method of statement 1 or statement 2, comprising:
obtaining a commitment transaction, wherein the commitment transaction comprises the user seed data item generated by the current user; and
transmitting the commitment transaction to a blockchain network for inclusion in a blockchain.

Statement 5. The method of statement 3 or statement 4, wherein the game transaction comprises a first input configured to unlock a first output of the commitment transaction.

Statement 6. The method of any of statements 1 to 5, wherein the first pseudorandom number is generated by:
applying a first hash function to a combination of the set of seed data items to generate a first hash result; and
mapping the first hash result to a number based on a first total number of first game elements in the set of first game elements.

Statement 7. The method of statement 6, wherein said mapping comprises taking a first modulus of the first hash result, wherein said first total number is the first modulus.

Statement 8. The method of any preceding statement, comprising:
generating a mapping hash by applying a hash function to a mapping on the sequence of public keys and the respective first game elements represented by those public keys; and
making available the mapping hash to at least the current user.

Statement 9. The method of statement 8, wherein said making available of the mapping hash comprises including the mapping hash in a transaction for inclusion in the blockchain.

Statement 10. The method of any preceding statement, wherein said obtaining of the set of seed data items comprises obtaining the respective user seed data items from respective users.

Statement 11. The method of any preceding statement, wherein said obtaining of the sequence of first public keys comprises obtaining one or more of said first public keys from the current user.

Statement 12. The method of any preceding statement, wherein the first output script is configured to, when executed, lock the first output to the first winning public key.

Statement 13. The method of statement 12, comprising, transmitting, to the current user, a private key corresponding to the first winning public key.

Statement 14. The method of any of statements 1 to 11, wherein the first output script is configured to, when executed, lock the first output to a) one or more user public keys associated with the current user, or b) an oracle public key associated with the oracle, wherein the first output is locked to either a) the one or more user public keys, or b) the oracle public key, based on the first winning public key.

Statement 15. The method of any of statements 1 to 11, wherein the game comprises a set of second game elements used to determine the outcome of the game, and wherein the method comprises:
obtaining a sequence of second public keys, each second public key representing a respective one of the set of second game elements; and
wherein the output script is configured to, when executed, generate a second pseudorandom number, the second pseudorandom number being based on the set of seed data items, and to select, as a second winning public key, a public key at a position in the sequence of second public keys corresponding to the second pseudorandom number.

Statement 16. The method of statement 15, wherein the second pseudorandom number is generated by:
applying a second hash function to a combination of the set of seed data items to generate a second hash result; and
mapping the second hash result to a number based on a second total number of second game elements in the set of second game elements.

Statement 17. The method of statement 16, wherein said mapping of the second hash result comprises taking a second modulus of the second hash result, wherein said second total number is the second modulus.

Statement 18. The method of any of statements 15 to 17, wherein the first output script is configured to, when executed, lock the first output to a) one or more user public keys associated with the current user, or b) an oracle public key, wherein the first output is locked to either a) the one or more user public keys, or b) the oracle public key, based on the first winning public key corresponding to at least the second winning public key.

Statement 19. The method of statement 18, wherein the first output script comprises a multi-signature script for locking the first output to a) one or more user public keys.

Statement 20. The method of any preceding statement, wherein one or more first public keys represent the same first game element, and/or wherein one or more second public keys represent the same second game element.

Statement 21. The method of any preceding statement, comprising transmitting the game transaction to one or more of the respective users and/or the blockchain network.

Statement 22. A transaction for inclusion in a blockchain, the transaction comprising:
an output, wherein the output comprises an output script comprising a sequence of public keys, each public key representing a respective one of a set of game elements, and wherein the output script is configured to generate at least one first pseudorandom number, the at least one first pseudorandom number being based on a set of seed data items, wherein the set of seed data items comprises one or more user seed data items generated by a respective user, and wherein the output script is configured to select at least one first winning key, the at least one first winning public key being the public key at a position in the sequence of public keys corresponding to the at least one first pseudorandom number.

Statement 23. A computer-readable storage medium having stored thereon the transaction of statement 22.

Statement 24. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 21.

Statement 25. A computer program embodied on computer-readable storage and configured so as, when run on computer equipment of statement 24, to perform the method of any of statements 1 to 21.

According to another aspect of the teachings disclosed herein, there may be provided a method comprising the actions of the oracle and the user.

According to another aspect of the teachings disclosed herein, there may be provided a system comprising the computer equipment of the oracle and the user.

Other variants may become apparent to a person skilled in the art once given the disclosure herein. The scope of the present disclosure is not limited by the disclosed embodiments but only by the accompanying claims.

1. A computer-implemented method of pseudo-randomly generating winning game elements for use in playing a game, wherein the game comprises a set of first game elements used to determine an outcome of the game, wherein the game is played by one or more respective users, and wherein the method is performed by an oracle and comprises:
obtaining a set of seed data items, wherein the set of seed data items comprises one or more user seed data items generated by a respective user;
obtaining a sequence of first public keys, each first public key representing a respective one of the set of first game elements;
generating a first output of a game transaction, wherein the game transaction is a blockchain transaction, wherein the first output comprises an output script comprising the sequence of at least some of the first public keys, and wherein the output script is configured to, when executed, generate at least one first pseudorandom number, the at least one first pseudorandom number being based on the set of seed data items, and to select at least one first winning key, the at least one first winning public key being the public key at a position in the sequence of first public keys corresponding to the at least one first pseudorandom number.

2. The method of claim 1, comprising transmitting the game transaction to one or more of the respective users and/or the blockchain.

3. The method of claim 1, wherein the set of seed data items comprises an oracle seed data item generated by the oracle.

4. The method of claim 1, comprising:
generating a commitment transaction, wherein the commitment transaction is a blockchain transaction comprising the oracle seed data item; and
transmitting the commitment transaction to a current user of the respective users.

5. The method of claim 1, comprising:
obtaining a commitment transaction, wherein the commitment transaction comprises the user seed data item generated by a current user; and
transmitting the commitment transaction to a blockchain network for inclusion in a blockchain.

6. The method of claim 4, wherein the game transaction comprises a first input configured to unlock a first output of the commitment transaction.

7. The method of claim 1, wherein the first pseudorandom number is generated by:
applying a first hash function to a combination of the set of seed data items to generate a first hash result; and
mapping the first hash result to a number based on a first total number of first game elements in the set of first game elements.

8. (canceled)

9. The method of claim 1, comprising:
generating a mapping hash by applying a hash function to a mapping on the sequence of public keys and the respective first game elements represented by those public keys; and
making available the mapping hash to at least a current user.

10. The method of claim 9, wherein said making available of the mapping hash comprises including the mapping hash in a transaction for inclusion in the blockchain.

11. (canceled)

12. The method of claim 1, wherein said obtaining of the sequence of first public keys comprises obtaining one or more of said first public keys from a current user.

13. The method of claim 1, wherein the first output script is configured to, when executed, lock the first output to the first winning public key.

14. The method of claim 13, comprising, transmitting, to a current user, a private key corresponding to the first winning public key.

15. The method of claim 1, wherein the first output script is configured to, when executed, lock the first output to a) one or more user public keys associated with a current user, or b) an oracle public key associated with the oracle, wherein the first output is locked to either a) the one or more user public keys, or b) the oracle public key, based on the first winning public key.

16. The method of claim 1, wherein the game comprises a set of second game elements used to determine the outcome of the game, and wherein the method comprises:
obtaining a sequence of second public keys, each second public key representing a respective one of the set of second game elements; and
wherein the output script is configured to, when executed, generate a second pseudorandom number, the second pseudorandom number being based on the set of seed data items, and to select, as a second winning public key, a public key at a position in the sequence of second public keys corresponding to the second pseudorandom number.

17. The method of claim 16, wherein the second pseudorandom number is generated by:
applying a second hash function to a combination of the set of seed data items to generate a second hash result; and
mapping the second hash result to a number based on a second total number of second game elements in the set of second game elements.

18. (canceled)

19. The method of claim 16, wherein the first output script is configured to, when executed, lock the first output to a) one or more user public keys associated with a current user, or b) an oracle public key, wherein the first output is locked to either a) the one or more user public keys, or b) the oracle public key, based on the first winning public key corresponding to at least the second winning public key.

20. The method of claim 19, wherein the first output script comprises a multi-signature script for locking the first output to a) one or more user public keys.

21. The method of claim 1, wherein one or more first public keys represent the same first game element, and/or wherein one or more second public keys represent the same second game element.

22-23. (canceled)

24. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs the method of pseudo-randomly generating winning game elements for use in playing a game, wherein the game comprises a set of first game elements used to determine an outcome of the game, wherein the game is played by one or more respective users, and wherein the method is performed by an oracle and comprises:
obtaining a set of seed data items, wherein the set of seed data items comprises one or more user seed data items generated by a respective user;
obtaining a sequence of first public keys, each first public key representing a respective one of the set of first game elements;
generating a first output of a game transaction, wherein the game transaction is a blockchain transaction, wherein the first output comprises an output script comprising the sequence of at least some of the first public keys, and wherein the output script is configured to, when executed, generate at least one first pseudorandom number, the at least one first pseudorandom number being based on the set of seed data items, and to select at least one first winning key, the at least one first winning public key being the public key at a position in the sequence of first public keys corresponding to the at least one first pseudorandom number.

25. A computer program product comprising a non-transitory computer-readable storage medium storing a computer program configured so as, when run on computer equipment, the computer equipment performs the method of any of pseudo-randomly generating winning game elements for use in playing a game, wherein the game comprises a set of first game elements used to determine an outcome of the game, wherein the game is played by one or more respective users, and wherein the method is performed by an oracle and comprises:
obtaining a set of seed data items, wherein the set of seed data items comprises one or more user seed data items generated by a respective user;
obtaining a sequence of first public keys, each first public key representing a respective one of the set of first game elements;
generating a first output of a game transaction, wherein the game transaction is a blockchain transaction, wherein the first output comprises an output script comprising the sequence of at least some of the first public keys, and wherein the output script is configured to, when executed, generate at least one first pseudorandom number, the at least one first pseudorandom number being based on the set of seed data items, and to select at least one first winning key, the at least one first winning public key being the public key at a position in the sequence of first public keys corresponding to the at least one first pseudorandom number.
